(19) United States
(12) Patent Application Publication
(10) Pub. No.: US 2004/0178335 A1
(43) Pub. Date: Sep. 16, 2004

(54) Image sensor having improved functions

(76) Inventors: Jackson Hsieh, Hsinchu Hsien (TW); Jichen Wu, Hsinchu Hsien (TW); Bruce Chen, Hsinchu Hsien (TW); Eric Chang, Hsinchu Hsien (TW)

Correspondence Address: PRO-TECHTOR INTERNATIONAL, 20775 Norada Court, Saratoga, CA, 95070-3018, US

(21) Appl. No.: 10/386,066

(22) Filed: Mar. 10, 2003

(51) Int. Cl. H01J 5/02

(52) U.S. Cl. 250/239

(57) ABSTRACT

An image sensor having improved functions. The image sensor includes a plurality of metal sheets arranged in a matrix, an insulation layer, a photosensitive chip, a plurality of wires, a glue layer, and a transparent layer. Each metal sheet has a first board and a second board. The insulation layer is adhered to the first boards to fix the first boards. The photosensitive chip is arranged on the first boards. The wires electrically connect the photosensitive chip to the first boards. The glue layer encapsulates the metal sheets with the first boards and second boards exposed from the glue layer, and the glue layer is formed with a projection edge. The transparent layer is placed on the projection edge to cover the photosensitive chip.

### BACKGROUND OF THE INVENTION

1. Field of the Invention

The invention relates to an image sensor having improved functions, and in particular to an image sensor having improved quality and increased pixels.

2. Description of the Related Art

Please refer to FIG. 1, which is a cross-sectional view showing an image sensor disclosed in a U.S. patent application Ser. No. 10/146,997, filed on May 15, 2002, and assigned to the same assignee as this application. The image sensor includes a substrate 70, a frame layer 72, a photosensitive chip 74, a plurality of wires 88, and a transparent layer 76. The substrate 70 is composed of a plurality of metal sheets arranged in a matrix, wherein each of the metal sheets has a first board 80 and a second board 82 located at a height different from that of the first board 80. The frame layer 72 is formed on a periphery and a bottom surface of the substrate 70. The frame layer 72 and the substrate 70 form a cavity 86. The top faces of the first boards 80 and the bottom faces of the second boards 82 are exposed from the frame layer 72. The photosensitive chip 74 is arranged within the cavity 86 that is defined by the frame layer 72 and the substrate 70. The wires 88 electrically connect the top faces of the first boards 80 to the photosensitive chip 74. The transparent layer 76 is placed on the frame layer 72 to cover the photosensitive chip 74.

In the above-mentioned disclosure, however, when the functions (e.g., the memory capacity and the like) of the photosensitive chip 74 are to be enhanced, the number of bonding pads of the photosensitive chip 74 has to be increased. In this case, each metal sheet has to be made small, and the gaps between adjacent metal sheets are also small. Consequently, the metal sheets may be formed at different heights to influence the wire-bonding process and the circuit connections, and the metal sheets may be short-circuited.

### SUMMARY OF THE INVENTION

An object of the invention is to provide an image sensor having improved functions, wherein a photosensitive chip having bonding pads arranged in a high-density manner may be packaged.

To achieve the above-mentioned object, the invention provides an image sensor having improved functions. The image sensor includes a plurality of metal sheets arranged in a matrix, an insulation layer, a photosensitive chip, a plurality of wires, a glue layer, and a transparent layer. Each metal sheet has a first board and a second board. The insulation layer is adhered to the first boards to fix the first boards. The photosensitive chip is arranged on the first boards. The wires electrically connect the photosensitive chip to the first boards. The glue layer encapsulates the metal sheets with the first boards and second boards exposed from the glue layer, and the glue layer is formed with a projection edge. The transparent layer is placed on the projection edge to cover the photosensitive chip.

Accordingly, the metal sheets may be kept at the same horizontal height so as to facilitate the wire-bonding process, and the metal sheets are free from being short-circuited.

### BRIEF DESCRIPTION OF THE DRAWINGS

FIG. 1 is a cross-sectional view showing an image sensor disclosed in a U.S. patent application Ser. No. 10/146,997, filed on May 15, 2002.

FIG. 2 is a top view showing an image sensor having improved functions of the invention without a photosensitive chip.

FIG. 3 is a cross-sectional view showing the image sensor having improved functions of the invention.

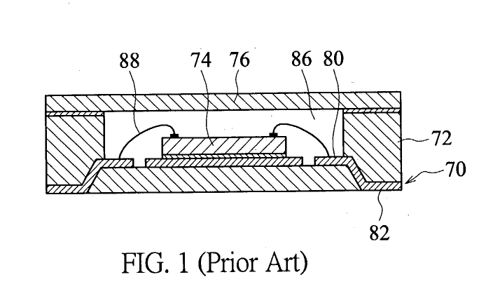

### DETAILED DESCRIPTION OF THE INVENTION

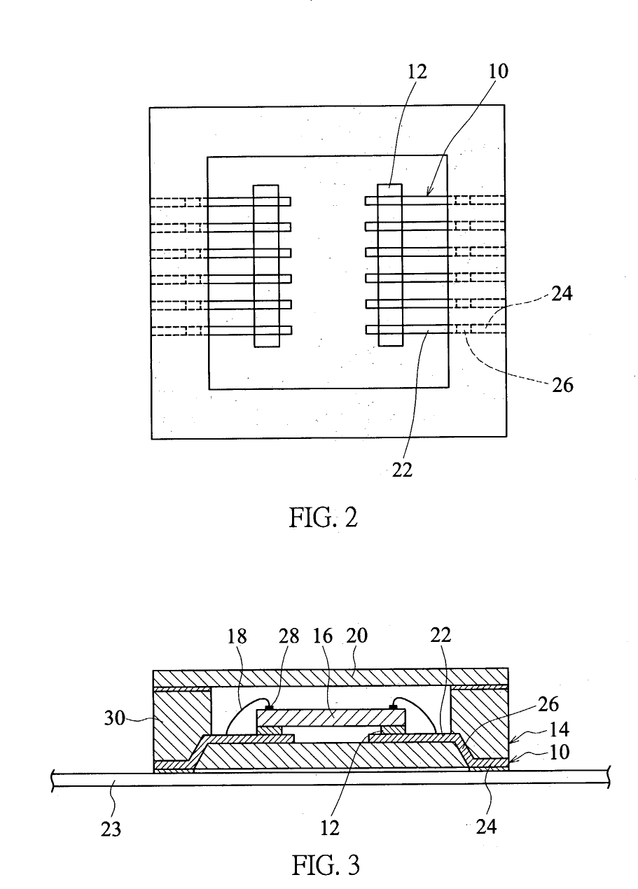

Referring to FIGS. 2 and 3, an image sensor having improved functions of the invention includes a plurality of metal sheets 10 arranged in a matrix, an insulation layer 12, a glue layer 14, a photosensitive chip 16, a plurality of wires 18 and a transparent layer 20.

Each of the metal sheets 10 has a first board 22, a second board 24, and a third board 26 connecting the first board 22 to the second board 24. The second boards 24 are electrically connected to a printed circuit board 23.

The insulation layer 12 of this embodiment is a double-faced tape adhered to the first boards 22 of the metal sheets 10 in order to fix the first boards 22 and keep the first boards 22 at the same horizontal height. In addition, the insulation layer 12 may also effectively prevent the first boards 22 from contacting each other. Consequently, the metal sheets 10 may be made very thin and small in conjunction with the photosensitive chip 16 having high-density bonding pads 28, and the functions of the image sensor may be improved accordingly.

The glue layer 14 may be made of a plastic material by way of injection molding or die pressing to encapsulate the plurality of metal sheets 10 with the first boards 22 and second boards 24 exposed from the glue layer 14. The glue layer 14 is formed with a projection edge 30.

The photosensitive chip 16 is placed on the first boards 22 of the metal sheets 10 and is formed with a plurality of bonding pads 28. In this embodiment, the photosensitive chip 16 is adhered to the insulation layer 12 on the first boards 22 of the metal sheets 10.

The wires 18 electrically connect the bonding pads 28 of the photosensitive chip 16 to the first boards 22 of the metal sheets 10, respectively.

The transparent layer 20 is a piece of transparent glass placed on the projection edge 30 of the glue layer 14 to cover the photosensitive chip 16.

Consequently, interconnecting the first boards 22 of the metal sheets 10 by the insulation layer 12 may keep the first boards 22 at the same horizontal height so as to facilitate the process for bonding the wires 18. In addition, by the fixation of the insulation layer 12, the thin metal sheets 10 may be spaced apart and free from being short-circuited. Therefore, the insulation layer 12 is advantageous to the condition when the density of the bonding pads 28 of the photosensitive chip 16 is to be increased in order to improve the functions of the image sensor.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An image sensor to be electrically connected to a printed circuit board, the image sensor comprising:
a plurality of metal sheets arranged in a matrix, each of the metal sheets having a first board and a second board, the second boards being electrically connected to the printed circuit board;
an insulation layer adhered to the first boards of the metal sheets to fix the first boards;
a glue layer for encapsulating the metal sheets with the first boards and second boards exposed from the glue layer, the glue layer being formed with a projection edge;
a photosensitive chip arranged on the first boards;
a plurality of wires for electrically connecting the photosensitive chip to the first boards; and
a transparent layer placed on the projection edge of the glue layer to cover the photosensitive chip.

2. The image sensor according to claim 1, wherein each of the metal sheets further has a third board, and the third boards connect the first boards to the second boards, respectively.

3. The image sensor according to claim 1, wherein the insulation layer is a double-faced tape, and the photosensitive chip is adhered to the double-faced tape.

4. The image sensor according to claim 1, wherein the glue layer is made of a plastic material by way of injection molding to encapsulate the plurality of metal sheets.

5. The image sensor according to claim 1, wherein the transparent layer is a piece of transparent glass.
